(19) United States
(12) Patent Application Publication
(10) Pub. No.: US 2013/0339766 A1
(43) Pub. Date: Dec. 19, 2013

(54) POWER SUPPLY DOCK WITH WIRELESS NETWORK AND POWER MANAGEMENT FUNCTIONS

(71) Applicants: Jiann-Jyh CHEN, Taipei City (TW); Guo-Yuan WANG, New Taipei City (TW)

(72) Inventors: Jiann-Jyh CHEN, Taipei City (TW); Guo-Yuan WANG, New Taipei City (TW)

(21) Appl. No.: 13/543,889

(22) Filed: Jul. 9, 2012

(30) Foreign Application Priority Data
Jun. 14, 2012 (TW) 101121282

(51) Int. Cl. G06F 1/26

(52) U.S. Cl. 713/300

(57) ABSTRACT

A power supply dock with wireless network and power management functions, comprising an enclosure, a wireless base station module and a control unit disposed in the enclosure, and a plurality of power supply sockets disposed on the enclosure. The wireless base station module communicates with an external first electric appliance via a wireless network. The power supply sockets are electrically connected to and supply power to the first electric appliance or an external second electric appliance. The power supply dock is connected with the utility power to power the wireless base station module so that the wireless network can be deployed quickly, and the coverage of the wireless network can be quickly enlarged through disposition of a plurality of such power supply docks.

### BACKGROUND OF THE INVENTION

1. Technical Field

The present invention relates to a power supply dock with wireless network and power management functions, and more particularly, to a power supply dock with a wireless network sharing capability and capable of turning on or off external electric appliances through remote control via a network signal.

2. Description of Related Art

Generally speaking, an indoor network is deployed in the following way: a user applies for network services from a network service provider, and deploys a modem in the house to connect with the Internet Service Provider (ISP); and then the modem is connected to a wireless router so that a plurality of computers, television (TV sets) or game machines can be connected with the modem via network cables to access network signals for purpose of network sharing.

However, for deployment of the indoor wired network, it takes much labor to deploy the network cables and the wireless router, which is costly for many small enterprises and domestic users. Furthermore, the cost and the network speed are different for different connection protocols.

In view of this, it is necessary to deployment wireless networks in order to save the cost of deploying the network cables and the wireless router and to allow for connection of different devices to the Internet. The wireless network has a more stable connection speed and more stable service quality and has a lower cost to use as compared to the indoor wired network. However, even when a wireless network is deployed in a house, there is also a problem that mostly the house cannot be fully covered by the wireless network, thus causing dead zones in the house.

Now, enlarging the wireless network coverage has become almost the sole way to solve the aforesaid problem. However, providing one or more additional wireless routers for only the purpose of eliminating the dead zones is cost ineffective. Accordingly, an urgent need exists in the art to enlarge the wireless network coverage in a convenient and low-cost way and to further reduce the deployment cost of the indoor network cables.

### BRIEF SUMMARY OF THE INVENTION

The present invention provides a power supply dock with a wireless network sharing capability and capable of turning on or off external electric appliances through remote control via a network signal, comprising:

an enclosure, having a power supply cable electrically connected to an external power supply end;

a wireless base station module disposed in the enclosure and electrically connected to the power supply cable, being configured to transmit/receive a network signal and use the network signal for wireless network communication with an external first electric appliance via a network communication protocol;

a control unit disposed in the enclosure and electrically connected to the wireless base station module and the power supply cable; and

a plurality of power supply sockets disposed on the enclosure respectively and electrically connected to the control unit, wherein the power supply sockets are configured to be electrically connected to and supply power to the first electric appliance or an external second electric appliance, and the wireless base station module is controlled by the network signal to drive the control unit to turn on or off the power supply sockets for powering the first electric appliance or the second electric appliance.

Thereby, the power supply dock powers the wireless base station module via the power supply cable to quickly deploy a wireless network, and the coverage of the wireless network can be quickly enlarged through disposition of a plurality of such power supply docks. Furthermore, the first electric appliance and the second electric appliance can be turned on or off through remote control by using the network signal to control power supply statuses of the power supply sockets.

Accordingly, the present invention provides a power supply dock which has a low deployment cost and can enlarge the communication coverage of the wireless network easily. The power supply dock can be incorporated into a pre-existing network architecture directly, so the deployment and extension of the wireless network can be accomplished very easily by general users. Thus, the objective of providing a power supply dock with a wireless network sharing capability and capable of turning on or off the first and the second electric appliances through remote control via a network signal is achieved.

Implementations of the present invention will be further described as follows.

The power supply dock described above further comprises a network input port disposed on the enclosure and electrically connected to the wireless base station module, wherein the network input port is configured to be electrically connected to an external modem, and the wireless base station module transmits/receives the network signal via the modem so that the first electric appliance performs network communication via the modem.

The power supply dock described above further comprises at least one network output port disposed on the enclosure and electrically connected to the wireless base station module, wherein the network output port is configured to be electrically connected to the first electric appliance, and the wireless base station module uses the network signal for wired network communication with the first electric appliance via the network communication protocol so that the first electric appliance performs network communication via the modem.

In the power supply dock described above, the control unit is a programmable logic controller (PLC), and the wireless base station module is controlled by the network signal to drive the PLC to control power supply scheduling of the power supply sockets so that the first electric appliance and the second electric appliance operate periodically. In this way, automatic control can be achieved by use of the control unit and the expense of the overall electric appliance can be reduced significantly, and this also contributes to environmental protection.

In the power supply dock described above, the network signal that controls the wireless base station module is transmitted by the first electric appliance.

In the power supply dock described above, the wireless base station module comprises a Wireless Fidelity (Wi-Fi) transmission chip.

The power supply dock described above further comprises an antenna unit disposed on the enclosure and electrically connected to the wireless base station module, wherein the antenna unit is configured to receive the network signal that has been processed by the wireless base station module and transmit the network signal outwards.

The power supply dock described above further comprises a USB port disposed on the enclosure and electrically connected to the wireless base station module, wherein the USB port is used for accessing the network signal and for power supplying.

### BRIEF DESCRIPTION OF THE SEVERAL VIEWS OF THE DRAWINGS

FIG. 1 is a schematic view illustrating an architecture of a preferred embodiment of the present invention;

FIG. 2 is a block diagram illustrating the architecture of the embodiment shown in FIG. 1;

FIG. 3 is a schematic view illustrating an architecture of an additional implementation of the embodiment shown in FIG. 1;

FIG. 4 is a schematic view illustrating an architecture of another additional implementation of the embodiment shown in FIG. 1; and

FIG. 5 is a schematic view illustrating an architecture of a further additional implementation of the embodiment shown in FIG. 1.

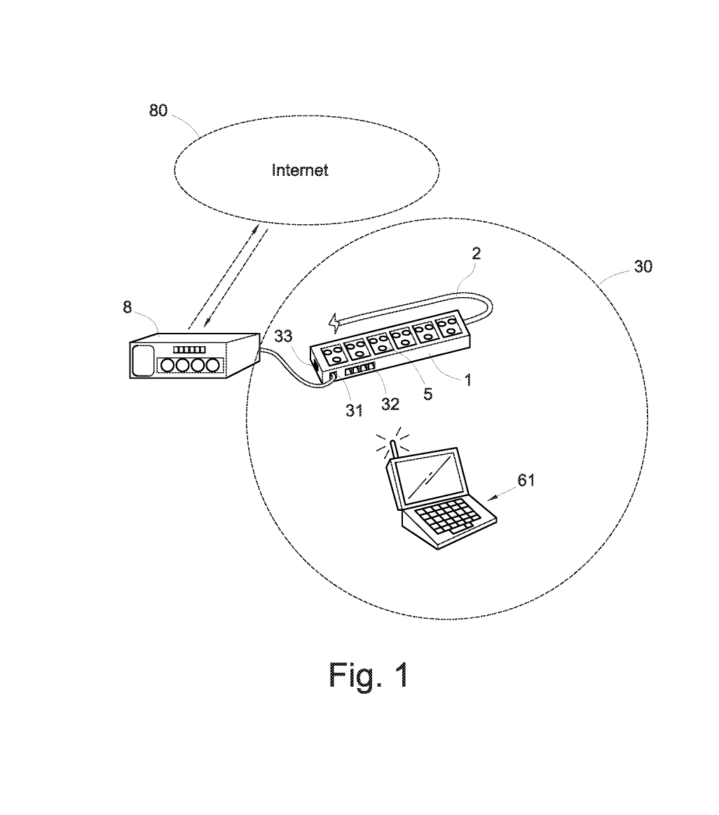

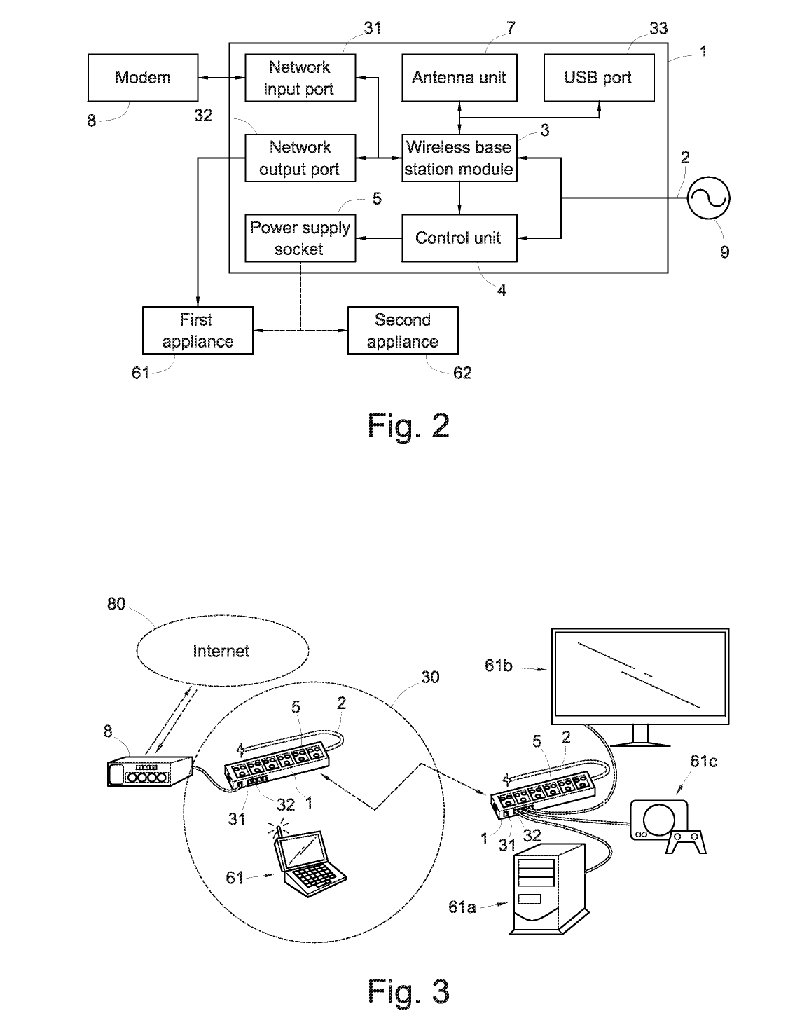

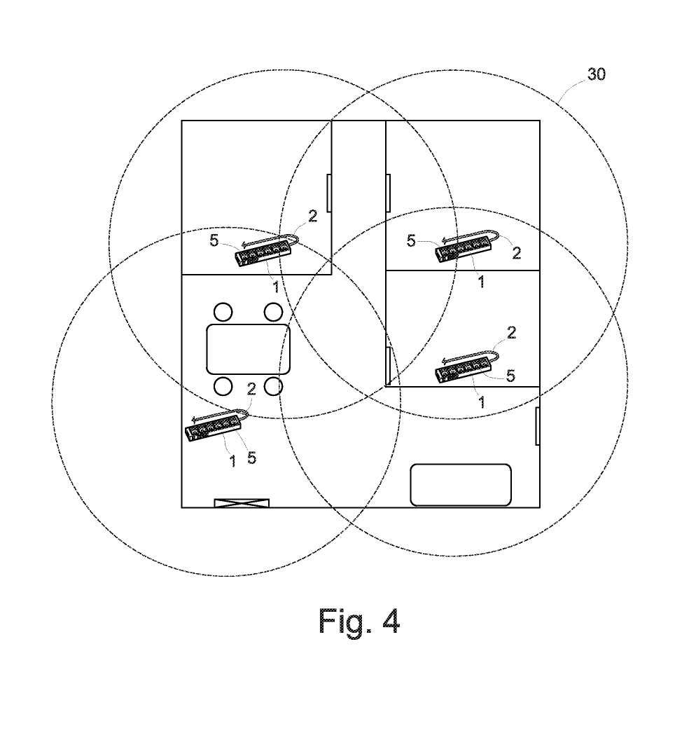

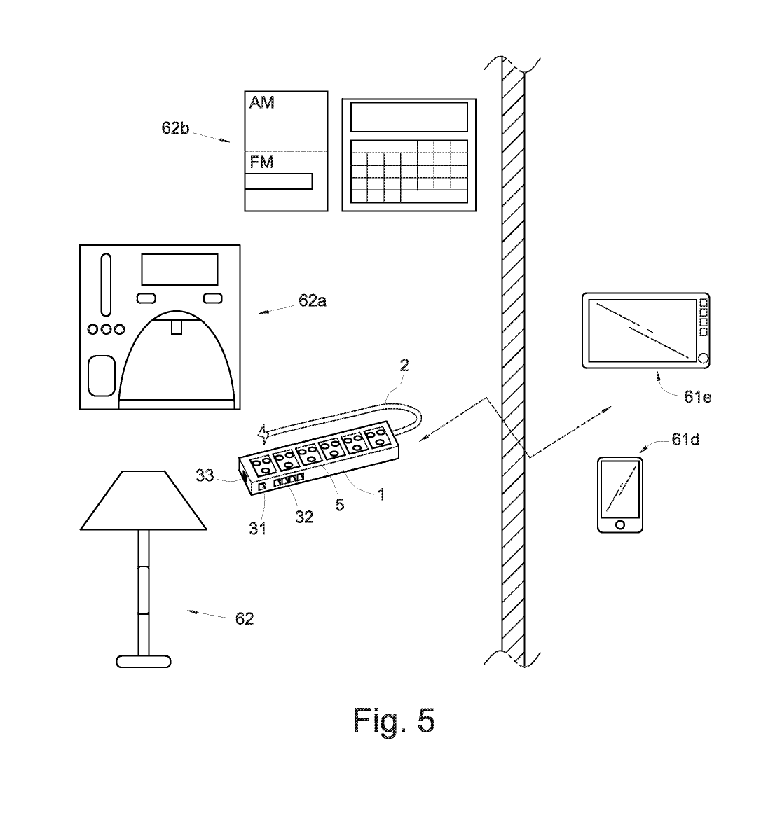

### DETAILED DESCRIPTION OF THE INVENTION

Referring to the attached drawings, there is disclosed a power supply dock with wireless network and power management functions of the present invention. The power supply dock comprises an enclosure 1, a wireless base station module 3, a control unit 4 and a plurality of power supply sockets 5.

The enclosure 1 may be in a strip form, and is provided with a power supply cable 2 thereon. The power supply cable 2 has a power supply plug (not shown) at an end thereof, and can be connected to an external power supply end 9 via the power supply plug so that the power supply cable 2 is electrically connected to the power supply end 9. The power supply end 9 may be an indoor alternating current (AC) power supply socket.

The wireless base station module 3 is disposed inside the enclosure 1 and is electrically connected to the power supply cable 2. The wireless base station module 3 comprises a Wireless Fidelity (Wi-Fi) transmission chip. The wireless base station module 3 may be connected to an external backbone network, 3G network or 4G network (e.g., GPRS, WIMAX, and etc.) to transmit/receive a network signal and process the network signal. The wireless base station module 3 can use the network signal for wireless network communication with an external first electric appliance 61 via a network communication protocol.

Thus, the power supply dock can provide the wireless network sharing function, and may be used as a wireless network sharer (or called a “wireless access point (AP)”) by the user. That is, the power supply dock can provide the wireless transmission function for the first electric appliance 61.

The control unit 4 is disposed in the enclosure 1 and is electrically connected to the wireless base station module 3 and the power supply cable 2.

The power supply sockets 5 are disposed on an outer surface of the enclosure 1 respectively and are electrically connected to the control unit 4. The power supply sockets 5 are configured to be electrically connected to and supply power to the first electric appliance 61 or an external second electric appliance 62. The wireless base station module 3 is controlled by the network signal to drive the control unit 4 to turn on or off the power supply sockets 5 for powering the first electric appliance 61 or the second electric appliance 62.

When not being used as a wireless network sharer, the power supply dock may also be used as only a power supply dock; that is, the power supply dock supplies power to the first electric appliance 61 or the second electric appliance 62 via the power supply sockets 5.

The first electric appliance 61, 61a, 61b, 61c may be any of electric appliances with network accessing and transmission capabilities such as hand-held devices, portable devices, personal digital assistants (PDAs), multiprocessor systems, microprocessor-based or programmable consumer electronics, mobile phones, network computers, minicomputers, notebook computers, mainframes, television (TV) sets, game machines and similar apparatuses, although the present invention is not limited thereto. The second electric appliance 62, 62a, 62b may be any of electric appliances without network accessing and transmission capabilities such as table lamps, water fountains, radios, electric fans, washing machines and other domestic appliances.

According to the above descriptions, the power supply cable 2 of the power supply dock may be connected to the utility power so that the wireless base station module 3 is powered via the power supply cable 2 to quickly deploy a wireless network indoors. Through disposition of a plurality of power supply docks, the communication coverage 30 of the wireless network can be quickly enlarged; and by using the network signal to control power supply statuses of the power supply sockets 5, the first electric appliance 61 and the second electric appliance 62 can be turned on or off through remote control. Thereby, the impediment to signal transmission can be reduced, which can improve the connection quality of the wireless network.

The present invention further comprises more specific implementations as follows.

In use, the power supply dock further comprises a network input port 31 disposed on the outer surface of the enclosure 1 and electrically connected to the wireless base station module 3. The network input port 31 is configured to be electrically connected to an external modem 8, which can be connected to the Internet 80. Thus, the wireless base station module 3 can transmit/receive the network signal via the modem 8 so that the first electric appliance 61 performs network communication and connects to the Internet 80 via the modem 8.

In use, the power supply dock further comprises an antenna unit 7 disposed in the enclosure 1 and electrically connected to the wireless base station module 3. The antenna unit 7 is configured to receive the network signal that has been processed by the wireless base station module 3 and transmit the network signal outwards. The first electric appliance 61, 61a, 61b, 61c can be wirelessly connected with the wireless base station module 3 via the antenna unit 7 so as to be connected to the modem 8 and receive network services via the modem 8.

In use, the power supply dock further comprises at least one network output port 32 disposed on the enclosure 1 and electrically connected to the wireless base station module 3. The network output port 32 is also configured to be electrically connected to the first electric appliance 61, 61a, 61b, 61c, and the wireless base station module 3 uses the network signal for wired network communication with the first electric appliance 61, 61a, 61b, 61c via the network communication protocol so that the first electric appliance 61, 61a, 61b, 61c performs network communication via the modem 8. The network input port 31 and the network output port 32 may be RJ-45 connectors.

In use, the control unit 4 maybe a programmable logic controller (PLC), and the wireless base station module 3 is controlled by the network signal to drive the PLC to control power supply scheduling of the power supply sockets 5 so that the first electric appliance 61, 61a, 61b, 61c and the second electric appliance 62, 62a, 62b operate periodically.

In a specific implementation, the power supply sockets 5 can be connected to the second electric appliance 62, 62a, 62b to power the second electric appliance 62, 62a, 62b; and the first electric appliance 61d, 61e maybe an electric appliance such as a smart mobile device or a PDA.

The wireless base station module 3 can receive the network signal transmitted from the external via the antenna unit 7, and the network signal that controls the wireless base station module 3 can be transmitted by the first electric appliance 61, 61a, 61b, 61c, 61d, 61e to the control unit 4 to be processed.

The network signal may be mainly related to a control command of the first electric appliance 61, 61a, 61b, 61c or the second electric appliance 62, 62a, 62b. After receiving the network signal, the control unit 4 can control the control command of the first electric appliance 61, 61a, 61b, 61c or the second electric appliance 62, 62a, 62b to be turned on or off according to the contents of the network signal.

Thus, the user can use the first electric appliance 61d, 61e to send the network signal so that the wireless base station module 3 receives the network signal and the control unit 4 is controlled by the network signal. Thereby, power supply scheduling of the second electric appliance 62, 62a, 62b is controlled through the power supply sockets 5 to achieve the purpose of automatic control. Moreover, the expense of the overall electric appliance can be reduced significantly, and this also contributes to environmental protection.

In use, the power supply dock further comprises a USB port 33 disposed on an outer wall of the enclosure 1 and electrically connected to the wireless base station module 3 and the control unit 4. The USB port 33 can be connected to the first electric appliance 61, 61a, 61b, 61c, 61d, 61e via a network cable, and can be used to access the network signal and supply power to the first electric appliance 61, 61a, 61b, 61c, 61d, 61e. Therefore, the USB port 33 has power supplying and charging capabilities.

As can be known from this, installation of the power supply dock is as simple as insertion of a power supply extension cable. Therefore, it is unnecessary for the user to know the complex network configuration method, and the basic network deployment can be completed so long as the power supply cable 2 of the power supply dock is inserted into the power supply sockets. Meanwhile, the wireless network can be accessed conveniently in the communication coverage 30.

In general environments deployed with a wired network, one modem 8 for communicating with an Internet service provider is needed for use as a gateway connected to the Internet 80. Therefore, the user can connect the network input port 31 of the power supply dock with the modem 8 directly, supply power necessary for the modem 8 through the power supply sockets 5, and use the function of the wireless network sharer to manage accessing of the Internet 80 by the user.

When the user desires to exlarge the coverage of the wireless network, it is only necessary to increase the number of the power supply docks of the present invention in the space and to add new power supply docks through the Wi-Fi Protected Setup. This can completely eliminate troubles in setting for users who do not well know how to set the wireless network. Moreover, the users can not only have existing wired networking devices (e.g., computers, smart TVs or game consoles) powered via the power supply dock, but also connect the existing wired networking devices with the network output port 32 together so that these devices can directly access the Internet 80 via the wireless network.

In many regions where labors are expensive, employing a special person to deploy the indoor wired network is costly. If the power supply dock of the present invention is used to deploy a network within a reasonable coverage, then not only accessing stability of the wireless network can be achieved, but also the electric appliances, which originally do not have the function of accessing the wireless network, can be provided with the function of accessing the wireless network through the design of the network output port 32. Furthermore, because the power supply sockets 5 of the power supply dock are available for use by the user, the power supply dock also satisfies the needs for power supply extension cables of the user when it is disposed indoors.

By increasing the number of the power supply docks, the communication coverage of the wireless network can be enlarged and the wireless signal strength be enhanced so that a more stable network accessing quality can be achieved for electric appliances such as the first electric appliance 61. For users who don't want to see crowded cables in the indoor environment, the inaesthetic appearance caused by routing of the network cables is avoided, and network deployment between different floors is made more convenient, which is very economical in use.

The power supply dock of the present invention has the function of controlling power supply of individual power supply sockets 5 respectively, so the user can directly connect the first electric appliances 61d, 61e (e.g., a smart mobile phone, a tablet computer or the like) to the wireless base station module 3 of the power supply dock and, by means of corresponding control software, control any of the power supply sockets 5 to be turned on or off. Thus, even when being located at a remote site, the user can still manipulate the on/off statuses of the first electric appliances 61, 61a, 61b, 61c or the second electric appliances 62, 62a, 62b through remote control. Also, because of the advantage of programmable scheduling, the user can schedule the individual power supply sockets 5 to be turned on or off periodically or at specific time points so that the troublesome repeated operations to be executed by the user himself can be eliminated and the cost can be reduced.

Thus, when the user goes out for work, he may schedule electric appliances having high power consumption to be turned off automatically and then turned on automatically before he is going back home. This not only saves the energy, but also avoids potential damage caused by repeated plugging and removal of the power supply cables.

Additionally, through design of the control unit 4, the power supply dock of the present invention has the function of intelligently resuming the power after a power failure. In this way, after the power supply resumes after the power failure, an overhigh instantaneous current load which would otherwise be caused when all the power supply sockets 5 supply power simultaneously can be avoided to prevent public safety accidents such as tripping or arcing. Instead, through program control, the power supply sockets are scheduled to supply power in sequence and alternately to ensure that the first electric appliances 61, 61a, 61b, 61c or the second electric appliances 62, 62a, 62b can resume normal operations.

Accordingly, the present invention provides a power supply dock which has a low deployment cost and can enlarge the communication coverage of the wireless network. It allows for quick deployment of an indoor network desired by a user and saves the cost of deploying a costly wired network and, meanwhile, can provide a wireless network of stable quality. Furthermore, because the power supply dock incorporates the power supplying function which is indispensable to people's daily life, the user can install the power supply dock according to the original habits of deploying power supply sockets while still achieving the purpose of enlarging the communication coverage of the wireless network. Also, the power supply dock can be incorporated into a pre-existing network architecture directly, so the deployment and extension of the wireless network can be accomplished very easily by general users.

Furthermore, because the power supply dock of the present invention is uniquely designed to integrate the power supply sockets 5 therein, the user can directly control the power supply statuses of the individual power supply sockets 5 via various networking appliances so as to ensure management of the first electric appliances 61, 61a, 61b, 61c or the second electric appliances 62, 62a, 62b through remote control; the user may also schedule periodic use of the second electric appliances 62, 62a, 62b through use of the programmable power supply scheduling function of control unit 4; or, potential risks caused by an overhigh instantaneous current load can be avoided by means of the function of intelligently resuming power supply after a power failure.

For a user who is to deploy a wireless network for the first time, the power supply dock of the present invention allows for quick deployment of the wireless network; and for a user who wants to enlarge the communication coverage of a pre-existing wireless network, the power supply dock can also provide the users with more convenient and more functions of utility apart from enlarging the communication coverage.

What is claimed is:

1. A power supply dock with wireless network and power management functions, comprising:
an enclosure, having a power supply cable electrically connected to an external power supply end;
a wireless base station module disposed in the enclosure and electrically connected to the power supply cable, being configured to transmit/receive a network signal and use the network signal for wireless network communication with an external first electric appliance via a network communication protocol;
a control unit disposed in the enclosure and electrically connected to the wireless base station module and the power supply cable; and
a plurality of power supply sockets disposed on the enclosure respectively and electrically connected to the control unit, wherein the power supply sockets are configured to be electrically connected to and supply power to the first electric appliance or an external second electric appliance, and the wireless base station module is controlled by the network signal to drive the control unit to turn on or off the power supply sockets for powering the first electric appliance or the second electric appliance; and the power supply dock powers the wireless base station module via the power supply cable to quickly deploy a wireless network so that the coverage of the wireless network can be quickly enlarged through disposition of a plurality of power supply docks, and the first electric appliance and the second electric appliance can be turned on or off through remote control by using the network signal to control power supply statuses of the power supply sockets.

2. The power supply dock with wireless network and power management functions of claim 1, further comprising a network input port disposed on the enclosure and electrically connected to the wireless base station module, wherein the network input port is configured to be electrically connected to an external modem, and the wireless base station module transmits/receives the network signal via the modem so that the first electric appliance performs network communication via the modem.

3. The power supply dock with wireless network and power management functions of claim 1, further comprising at least one network output port disposed on the enclosure and electrically connected to the wireless base station module, wherein the network output port is configured to be electrically connected to the first electric appliance, and the wireless base station module uses the network signal for wired network communication with the first electric appliance via the network communication protocol so that the first electric appliance performs network communication via the modem.

4. The power supply dock with wireless network and power management functions of claim 1, wherein the control unit is a programmable logic controller (PLC), and the wireless base station module is controlled by the network signal to drive the PLC to control power supply scheduling of the power supply sockets so that the first electric appliance and the second electric appliance operate periodically.

5. The power supply dock with wireless network and power management functions of claim 1, wherein the network signal that controls the wireless base station module is transmitted by the first electric appliance.

6. The power supply dock with wireless network and power management functions of claim 1, wherein the wireless base station module comprises a Wireless Fidelity (Wi-Fi) transmission chip.

7. The power supply dock with wireless network and power management functions of claim 1, further comprising an antenna unit disposed on the enclosure and electrically connected to the wireless base station module, wherein the antenna unit is configured to receive the network signal that has been processed by the wireless base station module and transmit the network signal outwards.

8. The power supply dock with wireless network and power management functions of claim 1, further comprising a USB port disposed on the enclosure and electrically connected to the wireless base station module, wherein the USB port is used for accessing the network signal and for power supplying.
